(19) United States
(12) Patent Application Publication
(10) Pub. No.: US 2025/0022108 A1
(43) Pub. Date: Jan. 16, 2025

(54) METHOD FOR IMPROVING QUALITY OF CDSEM IMAGES

(71) Applicant: Shanghai Huali Integrated Circuit Corporation, Shanghai (CN)

(72) Inventor: Zhenbin Wang, Shanghai (CN)

(73) Assignee: Shanghai Huali Integrated Circuit Corporation, Shanghai (CN)

(21) Appl. No.: 18/748,253

(22) Filed: Jun. 20, 2024

(30) Foreign Application Priority Data
Jul. 11, 2023 (CN) 202310847816.7

(51) Int. Cl. G06T 5/70; G06T 3/40

(52) U.S. Cl. CPC G06T 5/70; G06T 3/40; G06T 2207/10061; G06T 2207/20064

(57) ABSTRACT

This application provides a method for improving quality of CDSEM images, including: reading CDSEM images of different formats and performing format conversion on the CDSEM images of different formats; selecting wavelet basis functions; setting the number N of wavelet decomposition levels; setting a threshold function and thresholds respectively corresponding to the number N of wavelet decomposition levels; performing wavelet decomposition to obtain scaling function coefficients of different levels and wavelet coefficients of different levels; performing threshold processing, including performing threshold processing on the wavelet coefficients of different levels, to obtain processed wavelet coefficients of each level; performing multidimensional wavelet reconstruction, including performing multidimensional wavelet reconstruction by using the scaling function coefficients and the processed wavelet coefficients of each of the different level, to obtain denoised CDSEM images; and performing image quality evaluation on the denoised CDSEM images.

### CROSS-REFERENCE TO RELATED APPLICATIONS

This application claims priority to Chinese patent application No. 202310847816.7, filed on Jul. 11, 2023, the disclosure of which is incorporated herein by reference in its entirety.

### TECHNICAL FIELD

This application relates to the field of semiconductor technology, and in particular to a method for improving quality of critical dimension scanning electron microscope (CDSEM) images of a semiconductor device.

### BACKGROUND

With the continuous reduction of semiconductor process nodes, especially process nodes at 40 nm and beyond have gradually become the mainstream of products, Optical Proximity Correction (OPC) has become an indispensable and important step in semiconductor processes. Establishing an accurate OPC model is a prerequisite for OPC correction, and the establishment of the OPC model cannot be achieved without high-quality CDSEM image measurement technology. Not only the OPC modeling, but also the analysis of OPC recipe optimization and the photolithography exposure conditions all rely on high-quality CDSEM images. However, the quality of CDSEM images is easily affected by photolithography parameter fluctuation, quality, development and drying of the photoresist, and interference from machines such as linewidth measurement equipment. All the above can easily lead to insufficient definition of CDSEM images, affecting subsequent CDSEM measurement accuracy.

### BRIEF SUMMARY

The application provides a method for improving quality of CDSEM images,

The application provides a method for improving quality of CDSEM images, at least including:
step 1: reading CDSEM images, including: reading CDSEM images of different formats and performing format conversion on the CDSEM images of different formats;
step 2: setting wavelet parameters, including: selecting wavelet basis functions; setting the number N of wavelet decomposition levels; setting a threshold function, and setting thresholds which correspond respectively to the number N of wavelet decomposition levels;
step 3: performing wavelet threshold processing and multidimensional wavelet reconstruction,
herein the wavelet decomposition is performed to obtain scaling function coefficients of different levels and wavelet coefficients of different levels,
herein the threshold processing includes performing threshold processing on the wavelet coefficients of different levels to obtain processed wavelet coefficients of each level,
herein the multidimensional wavelet reconstruction includes performing multidimensional wavelet reconstruction by using the scaling function coefficients and the processed wavelet coefficients of each level to obtain denoised CDSEM images; and
step 4: performing image quality evaluation on the denoised CDSEM images.

Exemplarily, in step 1, the CDSEM images of different formats include CDSEM images of JPEG, TIFF, PNG, and BMP formats.

Exemplarily, in step 1, performing format conversion on the CDSEM images of different formats includes converting color images into grayscale images and converting between different grayscale formats.

Exemplarily, in step 2, the wavelet basis functions include Haar wavelet, db4 wavelet, and coif3 wavelet.

Exemplarily, in step 2, the number N of wavelet decomposition levels is a positive integer less than or equal to 3.

Exemplarily, in step 2, the threshold function is a soft threshold function or a hard threshold function.

Exemplarily, in step 3, a method for obtaining the scaling function coefficients and wavelet coefficients of different levels includes: performing N-level wavelet decomposition on the CDSEM images read in step 1 according to the selected wavelet basis functions, the number N of wavelet decomposition levels, the threshold function and the thresholds to obtain scaling function coefficients and wavelet coefficients of different levels.

Exemplarily, in step 3, a method for performing the threshold processing includes filtering out high-frequency noise in the CDSEM images according to the set threshold function and thresholds.

Exemplarily, in step 4, the image quality evaluation is performed on the denoised CDSEM images by adopting Signal-to-Noise Ratio (SNR) and Peak Signal-to-Noise Ratio (PSNR) evaluation criteria.

As described above, the method for improving quality of CDSEM images provided in this application has the following beneficial effects: this application uses the principle of wavelet analysis to perform filtering on the CDSEM images to filter out less useful high-frequency and low-energy noise information in the images and to reserve more useful low-frequency and high-energy information, thus greatly improving the quality of CDSEM images after denoising through filtering, thereby improving the accuracy of wafer measurement. This method can obtain denoised CDSEM images without requiring additional equipment or re-exposure of the wafer, thus significantly reducing the time and cost of subsequent image processing.

### BRIEF DESCRIPTION OF THE DRAWINGS

FIG. 1 illustrates an original CDSEM image of normal contacts according to the embodiment of this disclosure.

FIG. 2a illustrates a CDSEM image of contacts after denoising through filtering by adopting a threshold of Haar wavelet on the original images in FIG. 1.

FIG. 2b illustrates a CDSEM image of contacts by adopting a scaling coefficient of first-level wavelet decomposition of Haar wavelet on the original images in FIG. 1.

FIG. 2c illustrates a CDSEM image of contacts by adopting a scaling coefficient of second-level wavelet decomposition of Haar wavelet on the original images in FIG. 1.

FIG. 3a illustrates a CDSEM image of contacts after denoising through filtering by adopting a threshold of db4 wavelet on the original images in FIG. 1.

FIG. 3b illustrates a CDSEM image of contacts by adopting a scaling coefficient of first-level wavelet decomposition of db4 wavelet on the original images in FIG. 1.

FIG. 3c illustrates a CDSEM image of contacts by adopting a scaling coefficient of second-level wavelet decomposition of db4 wavelet on the original images in FIG. 1.

FIG. 4a illustrates a CDSEM image of contacts after denoising through filtering by adopting a threshold of coif3 wavelet on the original images in FIG. 1.

FIG. 4b illustrates a CDSEM image of contacts obtained by adopting a scaling coefficient of first-level wavelet decomposition of coif3 wavelet on the original images in FIG. 1.

FIG. 4c illustrates a CDSEM image of contacts by adopting a scaling coefficient of second-level wavelet decomposition of coif3 wavelet on the original images in FIG. 1.

FIG. 5 is a table comparing between the SNR and PSNR of CDSEM images of contacts for scaling coefficients of first-level wavelet decomposition and second-level wavelet decomposition obtained after the three-level wavelet decomposition and reconstruction, under the three methods of Haar wavelet, db4 wavelet and coif3 wavelet applied on the original CDSEM image of normal contacts, according to the embodiment of this disclosure.

FIG. 6 illustrates an original CDSEM image of the abnormal contacts.

FIG. 7a illustrates a CDSEM image of contacts after denoising through filtering by adopting a threshold of Haar wavelet on the original images in FIG. 6.

FIG. 7b illustrates a CDSEM image of contacts adopting a scaling coefficient of first-level wavelet decomposition of Haar wavelet on the original images in FIG. 6.

FIG. 7c illustrates a CDSEM image of contacts by adopting a scaling coefficient of second-level wavelet decomposition of Haar wavelet on the original images in FIG. 6.

FIG. 8a illustrates a CDSEM image of contacts after denoising through filtering by adopting a threshold of db4 wavelet on the original images in FIG. 6.

FIG. 8b illustrates a CDSEM image of contacts by adopting a scaling coefficient of first-level wavelet decomposition of db4 wavelet on the original images in FIG. 6.

FIG. 8c illustrates a CDSEM image of contacts by adopting a scaling coefficient of second-level wavelet decomposition of db4 wavelet on the original images in FIG. 6.

FIG. 9a illustrates a CDSEM image of contacts after denoising through filtering by adopting a threshold of coif3 wavelet on the original images in FIG. 6.

FIG. 9b illustrates a CDSEM image of contacts by adopting a scaling coefficient of first-level wavelet decomposition of coif3 wavelet on the original images in FIG. 6.

FIG. 9c illustrates a CDSEM image of contacts by adopting a scaling coefficient of second-level wavelet decomposition of coif3 wavelet on the original images in FIG. 6.

FIG. 10 is a table comparing between the SNR and PSNR of CDSEM images of contacts for scaling coefficients of first-level wavelet decomposition and second-level wavelet decomposition obtained after the three-level wavelet decomposition and reconstruction, under the three methods of Haar wavelet, db4 wavelet and coif3 wavelet applied on the original CDSEM image of abnormal contacts, according to the embodiment of this disclosure.

FIG. 11 illustrates comparison data of Haar, db4 and coif3 wavelet filtering effects on 1026 CDSEM images.

FIG. 12 illustrates a flowchart of a method for improving quality of CDSEM images according to this disclosure.

### DETAILED DESCRIPTION OF THE EMBODIMENTS

The embodiments of this application will be described below through specific examples. Those skilled in the art can easily understand the other advantages and effects of this application from the content disclosed in this description. This application may also be implemented or applied through different specific embodiments. The details in this description may be modified or changed based on different perspectives and applications without deviating from the spirit of this application.

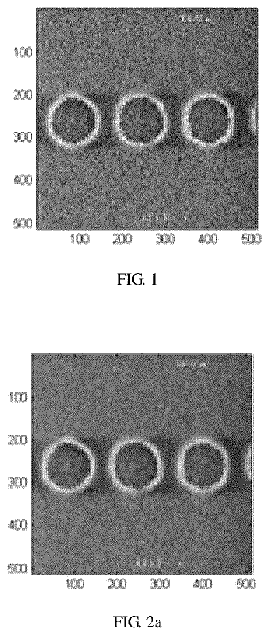

Please refer to FIG. 1 to FIG. 12. It should be noted that the drawings provided in the embodiments are only intended to schematically describe the basic concept of this application. Therefore, the drawings only illustrate the components related to this application, and are not drawn according to the number, shape, and size of the components during actual implementation. The type, quantity, and scale of each component during actual implementation may be randomly changed, and the layout of the component may also be more complex.

This application provides a method for improving quality of CDSEM images. This method uses the principle of wavelet analysis to perform filtering on the CDSEM images to filter out less useful high-frequency and low-energy noise information in the images and to reserve more useful low-frequency and high-energy information, thus greatly improving the quality of CDSEM images after denoising, and improving the accuracy of subsequent wafer measurement. Wavelet theory has received increasing attention in the field of image denoising due to its excellent time-frequency characteristics, pioneering the use of nonlinear methods for denoising. Specifically, wavelet denoising is mainly due to the following characteristics of wavelet transform: (1) low entropy: the sparse distribution of wavelet coefficients reduces the entropy of the transformed images, which means that after decomposing the signal (i.e., image), more wavelet basis coefficients tend to become zero (noise), and the main part of the signal is mainly concentrated in certain wavelet bases; using threshold denoising can better reserve the original signal; (2) multi-resolution characteristics: due to the use of multi-resolution methods, the non-stationary nature of the signal, such as mutation and breakpoint, can be well characterized (for example, 0-1 mutation cannot be reasonably represented by Fourier transform); noise can be eliminated at different resolutions based on the distribution of signals and noise; (3) decorrelation: wavelet transform can decorrelate signals, and noise tends to whiten after transformation, so wavelet domain is more conducive to denoising than time domain; (4) flexible selection of basis function: wavelet transform allows for flexible selection of basis function, and multiple band wavelets and wavelet packets can be selected according to signal characteristics and denoising requirements (wavelet packets decompose high-frequency signals again to improve time-frequency resolution); different wavelet basis functions can be selected for different scenarios; according to different processing methods based on wavelet coefficients, common denoising methods can be divided into three categories: (1) denoising based on wavelet transform modulus maximum (signal and noise modulus maximum will show different trends under wavelet transform), (2) denoising based on correlation between adjacent scale wavelet coefficients (noise has no obvious correlation between different scales of wavelet transform, while it is opposite for signals), and (3) denoising based on wavelet transform threshold.

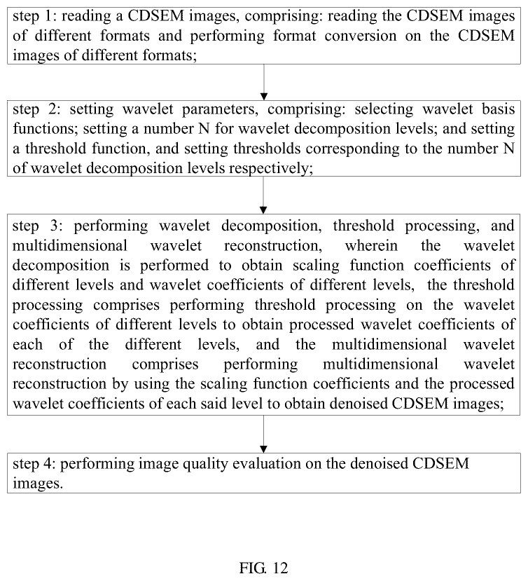

Referring to FIG. 12, it illustrates a flowchart of a method for improving quality of CDSEM images according to this application. The method at least includes the following steps:

In step 1, CDSEM images is read. Specifically, CDSEM images of different formats are read and format conversion is performed on the CDSEM images of different formats.

Further, in this embodiment of this application, in step 1, the CDSEM images of different formats include CDSEM images of JPEG, TIFF, PNG, and BMP formats.

Further, in this embodiment of this application, in step 1, performing format conversion on the CDSEM images of different formats includes converting color images into grayscale images and converting between different grayscale formats, such as converting unsigned integers into floating point numbers.

In step 2, wavelet parameters are set. Specifically, wavelet basis functions are selected; the number N of wavelet decomposition levels is set; and a threshold function and thresholds respectively corresponding to the number N of wavelet decomposition levels are set.

Further, in this embodiment of this application, in step 2, the wavelet basis functions include Haar wavelet, db4 wavelet, and coif3 wavelet.

Further, in this embodiment of this application, in step 2, the number N of wavelet decomposition levels is a positive integer less than or equal to 3.

Further, in this embodiment of this application, in step 2, the threshold function is a soft threshold function or a hard threshold function.

In step 3, wavelet decomposition, threshold processing and multidimensional wavelet reconstruction are performed.

The wavelet decomposition is performed to obtain scaling function coefficients of different levels and wavelet coefficients of different levels.

Further, in this embodiment of this application, in step 3, a method for obtaining the scaling function coefficients and wavelet coefficients of different levels includes: performing N-level wavelet decomposition on the CDSEM images read in step 1 according to the selected wavelet basis functions, the number N of wavelet decomposition levels, the threshold function and the thresholds to obtain scaling function coefficients and wavelet coefficients of different levels.

The threshold processing includes performing threshold processing on the wavelet coefficients of different levels to obtain processed wavelet coefficients of each level.

Further, in this embodiment of this application, in step 3, a method for performing the threshold processing includes filtering out high-frequency noise in the CDSEM images according to the set threshold function and thresholds.

The multidimensional wavelet reconstruction includes performing multidimensional wavelet reconstruction by using the scaling function coefficients and the processed wavelet coefficients of each level to obtain denoised CDSEM images.

In step 4, image quality evaluation is performed on the denoised CDSEM images.

Further, according to this embodiment of the disclosure, in step 4, the image quality evaluation is performed on the denoised CDSEM images by adopting Signal-to-Noise-Ratio (SNR) and Peak Signal-to-Noise-Ratio (PSNR) evaluation criteria.

$$S N R = 10 {log}_{10} ( \frac{{P}_{s}}{{P}_{n}} ) ,$$

where Pₛ and Pₙ are respectively the power of signal and the power of noise.

$$P S N R = 10 {log}_{10} ( \frac{{R}^{2}}{M S E} ) ,$$

where R is the maximum fluctuation value of an input image type and MSE is the mean square error. In a case that the image type is a double precision floating point number, then R=1; in a case that the image type is an 8-bit unsigned number, then R=255. To calculate PSNR, firstly MSE is calculated:

$$M S E = \frac{{\sum }_{M , N} {[ {I}_{1} ( m , n ) - {I}_{2} ( m , n ) ]}^{2}}{M * N} ,$$

where M and N are respectively the number of rows and the number of columns of input images.

Different image quality evaluation criteria have different emphases. For example, MSE is based on the mean square error of the image, SNR is based on the logarithm of the ratio of signal power to noise power as the evaluation criteria, and PSNR is mainly used to evaluate the magnitude of peak deviation. This application adopts SNR and PSNR as the criteria for evaluating image quality.

### Embodiments

Taking the CDSEM image of contacts of a device as an example, the process and method of filtering and denoising the CDSEM image by using wavelet analysis in this application will be described. This embodiment involves two situations, including CDSEM images of normal contacts, and CDSEM images of abnormal contacts containing a lot of noise.

### (I) For Original CDSEM Images of Normal Contacts

### Step 1: Input Parameter of Original CDSEM Image of Contacts

The input parameter of an original CDSEM image of contacts is 512×512 8-bit unsigned data, the image is in a JPEG format, and the size of the image is approximately 65 k.

### Step 2: Setting of Wavelet Parameters

Haar wavelet, db4 wavelet and coif3 wavelet are respectively selected as wavelet basis functions. The number N of wavelet decomposition levels is 3. A hard threshold function is adopted as a threshold function. Wavelet thresholds of three levels are set to 100, 150 and 200, respectively.

### Step 3: Wavelet Decomposition, Threshold Processing and Multidimensional Wavelet Reconstruction

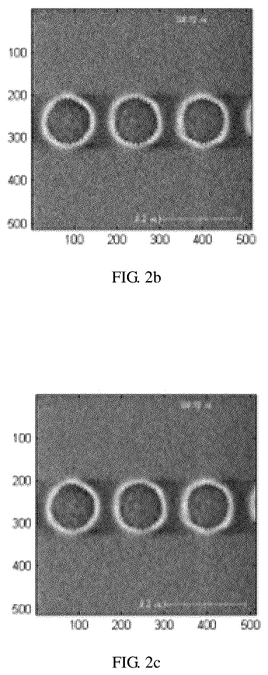

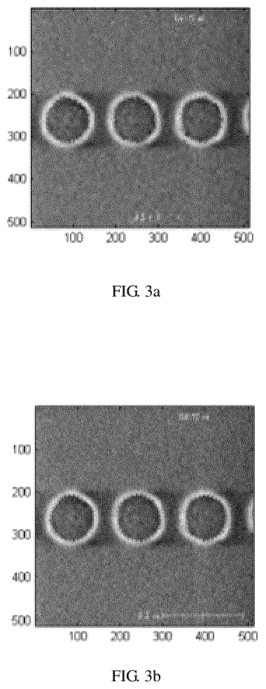

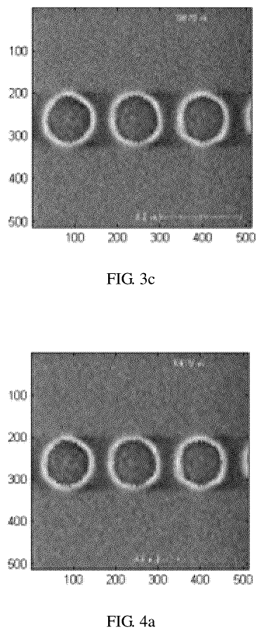

After 3-level wavelet decomposition, threshold filtering, and 3-level wavelet reconstruction, scaling coefficients of three levels and reconstructed CDSEM images of contacts are obtained respectively. FIG. 1 illustrates an original CDSEM image of normal contacts according to this application. FIG. 2a illustrates a CDSEM image of contacts after denoising through filtering by adopting a threshold of Haar wavelet on the original images in FIG. 1. FIG. 2b illustrates a CDSEM image of contacts by adopting a scaling coefficient of first-level wavelet decomposition of Haar wavelet on the original images in FIG. 1. FIG. 2c illustrates a CDSEM image of contacts by adopting a scaling coefficient of second-level wavelet decomposition of Haar wavelet on the original images in FIG. 1. FIG. 3a illustrates a CDSEM image of contacts after denoising through filtering by adopting a threshold of db4 wavelet on the original images in FIG. 1. FIG. 3b illustrates a CDSEM image of contacts by adopting a scaling coefficient of first-level wavelet decomposition of db4 wavelet on the original images in FIG. 1. FIG. 3c illustrates a CDSEM image of contacts by adopting a scaling coefficient of second-level wavelet decomposition of db4 wavelet on the original images in FIG. 1. FIG. 4a illustrates a CDSEM image of contacts after denoising through filtering by adopting a threshold of coif3 wavelet on the original images in FIG. 1. FIG. 4b illustrates a CDSEM image of contacts by adopting a scaling coefficient of first-level wavelet decomposition of coif3 wavelet on the original images in FIG. 1. FIG. 4c illustrates a CDSEM image of contacts by adopting a scaling coefficient of second-level wavelet decomposition of coif3 wavelet on the original images in FIG. 1.

### Step 4: Image Quality Evaluation on the Denoised CDSEM Images

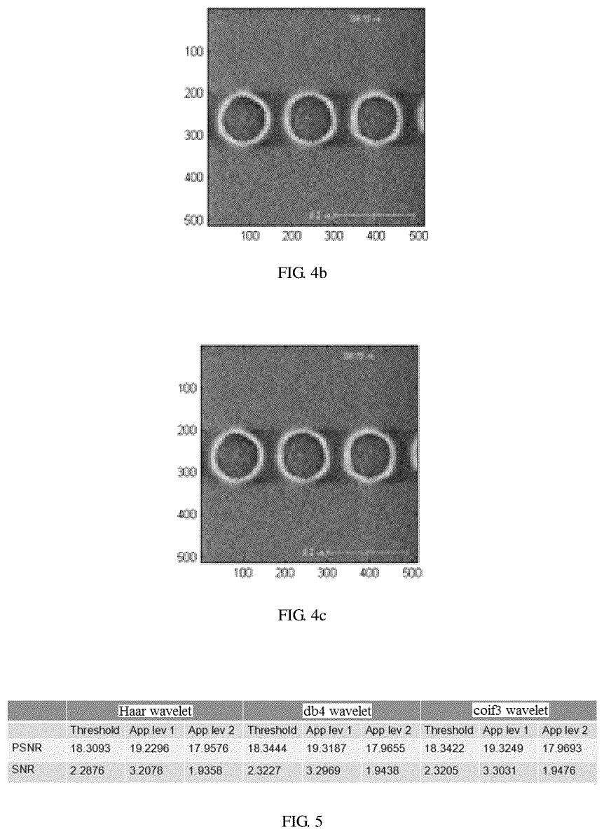

FIG. 5 is a table comparing between the SNR and PSNR of CDSEM images of contacts (Threshold) for scaling coefficients of first-level wavelet decomposition (App lev 1) and second-level wavelet decomposition (App lev 2) obtained after the three-level wavelet decomposition and reconstruction, under the three methods of Haar wavelet, db4 wavelet and coif3 wavelet applied on the original CDSEM image of normal contacts, according to the embodiment of this disclosure. From FIG. 2a to FIG. 4c and FIG. 5, for the Haar, db4 and coif3 wavelet filtering effects on the CDSEM image of normal contacts, the following comparison conclusions are derived: the filtering effects of the three wavelets are significantly improved compared to the original images, and the image noise is greatly suppressed; the filtering effects of the three wavelets are similar, and the comprehensive filtering effect of coif3 wavelet is the best; after three types of wavelet decomposition, PSNR and SNR corresponding to the first-level scaling coefficient are greater than those corresponding to the threshold filtering and the second-level coefficient, and the filtering effect is the best; most of the high-frequency noise in the original image is concentrated in the first-level wavelet decomposition coefficient, so just by taking the first-level scaling coefficient a satisfactory filtering effect can obtained; since most of the noise is concentrated in the first-level and second-level wavelet coefficients, it is not recommended to use more than three levels of wavelet decomposition, as image quality may actually deteriorate.

### (II) For Original CDSEM Image of Abnormal Contacts

The difference between the original CDSEM image of abnormal contacts and the original CDSEM image of normal contacts is only that the original CDSEM image of abnormal contacts contains more noise brought by the CDSEM machine, and other wavelet filtering conditions are the same as those for the original CDSEM image of normal contacts.

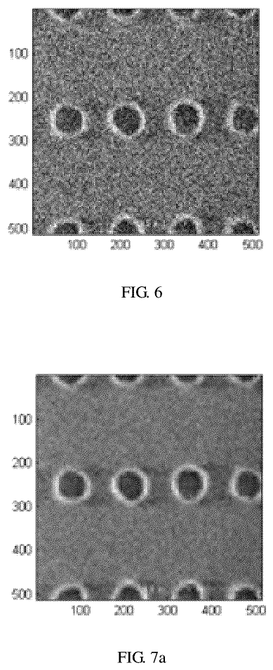

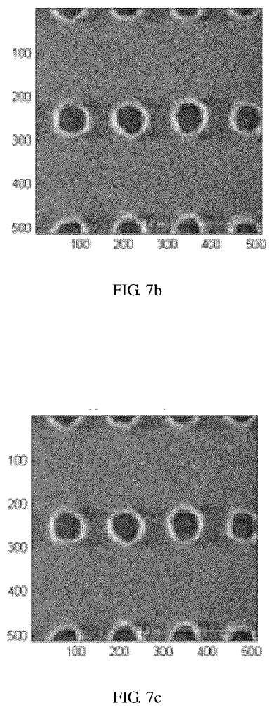

FIG. 6 illustrates an original CDSEM image of abnormal contacts. FIG. 7a illustrates a CDSEM image of contacts after denoising through filtering by adopting a threshold of Haar wavelet on the original images in FIG. 6. FIG. 7b illustrates a CDSEM image of contacts by adopting a scaling coefficient of first-level wavelet decomposition of Haar wavelet on the original images in FIG. 6. FIG. 7c illustrates a CDSEM image of contacts by adopting a scaling coefficient of second-level wavelet decomposition of Haar wavelet on the original images in FIG. 6.

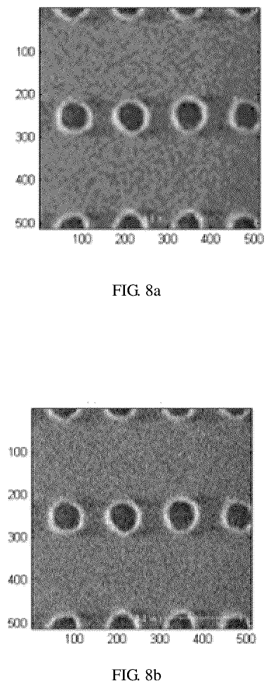

FIG. 8a illustrates a CDSEM image of contacts after denoising through filtering by adopting a threshold of db4 wavelet on the original images in FIG. 6. FIG. 8b illustrates a CDSEM image of contacts by adopting a scaling coefficient of first-level wavelet decomposition of db4 wavelet on the original images in FIG. 6. FIG. 8c illustrates a CDSEM image of contacts by adopting a scaling coefficient of second-level wavelet decomposition of db4 wavelet on the original images in FIG. 6.

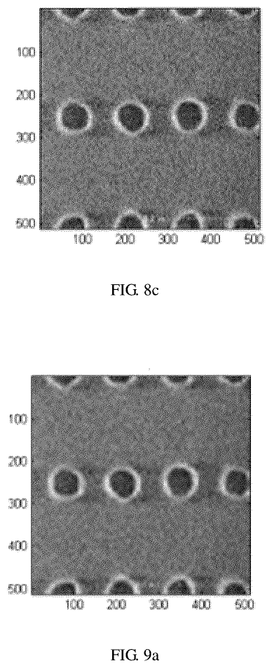

FIG. 9a illustrates a CDSEM image of contacts after denoising through filtering by adopting a threshold of coif3 wavelet on the original images in FIG. 6. FIG. 9b illustrates a CDSEM image of contacts by adopting a scaling coefficient of first-level wavelet decomposition of coif3 wavelet on the original images in FIG. 6. FIG. 9c illustrates a CDSEM image of contacts by adopting a scaling coefficient of second-level wavelet decomposition of coif3 wavelet on the original images in FIG. 6.

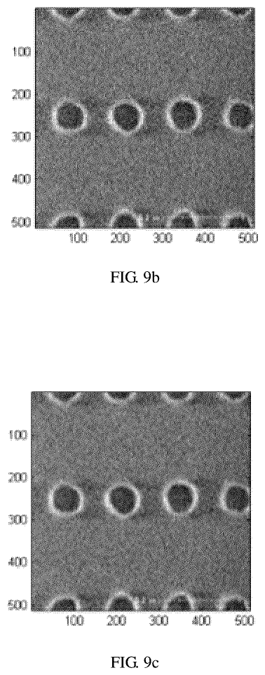

FIG. 10 is a table comparing between the PSNR and SNR of CDSEM images of contacts (Threshold) for scaling coefficients of first-level wavelet decomposition (App lev 1) and second-level wavelet decomposition (App lev 2) obtained after the three-level wavelet decomposition and reconstruction, under the three methods of Haar wavelet, db4 wavelet and coif3 wavelet applied on the original CDSEM image of abnormal contacts, according to the embodiment of this disclosure.

From FIG. 7a to FIG. 9c and FIG. 10, the following comparison conclusions are obtained for the Haar, db4 and coif3 wavelet filtering effects on the CDSEM image of abnormal contacts: the filtering effects of the three wavelets are significantly improved compared to the original images, and the noise is greatly suppressed; the filtering effects of the three wavelets are similar, and the comprehensive filtering effect of coif3 wavelet is the best; PSNR and SNR corresponding to the threshold filtering of the three wavelets are greater than those corresponding to the first-level coefficient and the second-level coefficient, and the filtering effect is the best; most of the high-frequency noise in the original image is significantly reduced after the first-level and second-level wavelet decomposition coefficients, so threshold filtering, first-level coefficient and second-level coefficient may be flexibly selected according to the actual situation; since most of the noise is concentrated in the first-level and second-level wavelet coefficients, it is not recommended to use more than three levels of wavelet decomposition, as image quality may actually deteriorate.

### (III) 1026 CDSEM Images of Contacts

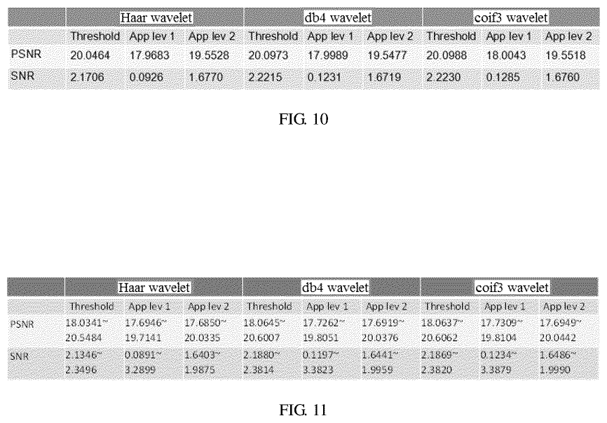

Refer to FIG. 11, which illustrates comparison of Haar, db4 and coif3 wavelet filtering effects on 1026 CDSEM images. From the comparison in FIG. 5, FIG. 10 and FIG. 11, the conclusions obtained from FIG. 11 are consistent with those obtained from FIG. 5 and FIG. 10.

To sum up, this application uses the principle of wavelet analysis to perform filtering on the CDSEM images to filter out less useful high-frequency and low-energy noise information in the images and to reserve more useful low-frequency and high-energy information, thus greatly improving the quality of CDSEM images after denoising through filtering, and improving the accuracy of wafer measurement. This method can obtain denoised CDSEM images without requiring additional equipment or re-exposure of the wafer, thus greatly reducing the time and cost of subsequent image processing. Therefore, this application effectively overcomes various disadvantages in the existing technology and thus has a great industrial utilization value.

The above embodiments only exemplarily describe the principle and effect of this application, and are not intended to limit this application. Those skilled in the art may modify or change the above embodiments without departing from the spirit and scope of this application. Therefore, all equivalent modifications or changes made by those skilled in the art without departing from the spirit and technical concept disclosed in this application should still be covered by the claims of this application.

What is claimed is:

1. A method for improving quality of critical dimension scanning electron microscope (CDSEM) images, at least comprising:
step 1: reading the CDSEM images, comprising: reading the CDSEM images of different formats and performing format conversion on the CDSEM images of different formats;
step 2: setting wavelet parameters, comprising: selecting wavelet basis functions; setting a number N for wavelet decomposition levels; and setting a threshold function, and setting thresholds corresponding to the number N of wavelet decomposition levels respectively;
step 3: performing wavelet decomposition, threshold processing, and multidimensional wavelet reconstruction,
wherein the wavelet decomposition is performed to obtain scaling function coefficients of different levels and wavelet coefficients of different levels,
wherein the threshold processing comprises performing threshold processing on the wavelet coefficients of different levels to obtain processed wavelet coefficients of each of the different levels, and
wherein the multidimensional wavelet reconstruction comprises performing multidimensional wavelet reconstruction by using the scaling function coefficients and the processed wavelet coefficients of each said level to obtain denoised CDSEM images; and
step 4: performing image quality evaluation on the denoised CDSEM images.

2. The method for improving the quality of the CDSEM images according to claim 1, wherein in step 1, the CDSEM images of different formats comprise CDSEM images of JPEG, TIFF, PNG, and BMP formats.

3. The method for improving the quality of the CDSEM images according to claim 1, wherein in step 1, the performing the format conversion on the CDSEM images of different formats comprises converting color images into grayscale images and converting between different grayscale formats.

4. The method for improving the quality of the CDSEM images according to claim 1, wherein in step 2, the wavelet basis functions comprise Haar wavelet, db4 wavelet, and coif3 wavelet.

5. The method for improving the quality of the CDSEM images according to claim 1, wherein in step 2, the number N of wavelet decomposition levels is a positive integer less than or equal to 3.

6. The method for improving the quality of the CDSEM images according to claim 1, wherein in step 2, the threshold function is a soft threshold function or a hard threshold function.

7. The method for improving the quality of the CDSEM images according to claim 1, wherein in step 3, a sub-method for obtaining the scaling function coefficients and wavelet coefficients of different levels comprises: performing N-level wavelet decomposition on the CDSEM images read in step 1 according to the selected wavelet basis functions, the number N of wavelet decomposition levels, the threshold function, and the thresholds to obtain the scaling function coefficients and wavelet coefficients of the different levels.

8. The method for improving the quality of the CDSEM images according to claim 1, wherein in step 3, a sub-method for performing the threshold processing comprises filtering out high-frequency noise from the CDSEM images according to the set threshold function and thresholds.

9. The method for improving the quality of the CDSEM images according to claim 1, wherein in step 4, the image quality evaluation is performed on the denoised CDSEM images by adopting signal-to-noise-ratio (SNR) and peak signal-to-noise-ratio (PSNR) evaluation criteria.
